(19) United States
(12) Patent Application Publication
(10) Pub. No.: US 2026/0052067 A1
(43) Pub. Date: Feb. 19, 2026

(54) METHODS AND SYSTEMS FOR SUSTAINABLY OPERATING COMPUTER NETWORK EQUIPMENT

(71) Applicant: SAUDI ARABIAN OIL COMPANY, Dhahran (SA)

(72) Inventors: Baraka H. Mutairi, Dhahran (SA); Fahad N. Khaldi, Dammam (SA); Abdulrahman S. Kamili, Khobar (SA); Amer A. Harthi, Khobar (SA); Awad M. AlMutairi, Khobar (SA)

(73) Assignee: SAUDI ARABIAN OIL COMPANY, Dhahran (SA)

(21) Appl. No.: 18/807,573

(22) Filed: Aug. 16, 2024

(51) Int. Cl. H04L 41/0833; H04L 41/0816; H04L 41/142; H04L 43/065

(52) U.S. Cl. CPC H04L 41/0833; H04L 41/0816; H04L 41/142; H04L 43/065

(57) ABSTRACT

A method includes transmitting network data between a computer and a plurality of computer network devices and obtaining device data from the computer and the plurality of computer network devices. In addition, the method includes obtaining facility data from a computer network facility. The method further includes storing the device data and the facility data in a system database and processing the device data and the facility data using a sustainability module resulting in a computer network metrics summary. The method yet further includes updating the system database using the computer network metrics summary, transmitting the computer network metrics summary to a user interface, determining, via the user interface, a sustainability adjustment based, at least in part, on the computer metrics summary, and applying the sustainability adjustment to the computer and the plurality of computer network devices to optimize the power usage of the plurality of computer network devices.

### BACKGROUND

Computing systems are necessary for supporting modern business and research. However, the operation of computing systems also results in a negative impact on the environment that often scales with the size of the computing system. On large scales, the operation of computing systems requires a significant utilization of energy in the form of electricity, which is typically produced from non-renewable resources. Further, some computing systems require specialized infrastructure and cooling systems, requiring additional electricity. Failure to operate computing systems effectively may result in breakdown and malfunction of their components, ultimately creating electronic waste that is difficult to recycle. In addition, replacing components for computing systems involves extraction of scarce resources which itself may also cause pollution. Accordingly, there exists a need to develop methods and systems for sustainably operating computing systems.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method for sustainably operating a plurality of computer network devices. The method includes transmitting network data between a computer and a plurality of computer network devices and obtaining device data from the computer and the plurality of computer network devices. The device data includes a power usage of the plurality of computer network devices. In addition, the method includes obtaining facility data from a computer network facility housing the computer and the plurality of computer network devices. The facility data includes a facility temperature. The method further includes storing the device data and the facility data in a system database and processing the device data and the facility data using a sustainability module resulting in a computer network metrics summary. The computer network metrics summary includes at least a portion of the processed device data and the processed facility data. The method yet further includes updating the system database using the computer network metrics summary, transmitting the computer network metrics summary to a user interface, determining, via the user interface, a sustainability adjustment to the computer and the plurality of computer network devices based, at least in part, on the computer metrics summary, and applying the sustainability adjustment to the computer and the plurality of computer network devices. Applying the sustainability adjustment optimizes the power usage of the plurality of computer network devices.

Embodiments disclosed herein generally relate to a system for sustainably operating a plurality of computer network devices. The system includes a computer network facility housing a computer and a plurality of computer network devices, a system database communicatively coupled to the computer and the plurality of computer network devices, a user interface communicatively coupled to the system database, and a sustainability module communicatively coupled to the user interface and the system database. The computer and the plurality of computer network devices are configured to transmit network data between the computer and the plurality of computer network devices. The system database is configured to receive device data from the computer and the plurality of computer network devices. The device data includes a power usage of the plurality of computer network devices. In addition, the system database is configured to receive facility data from a computer network facility housing the computer and the plurality of computer network devices. The facility data includes a facility temperature. The system database is further configured to store the device data and the facility data. The sustainability module is configured to process the device data and the facility data resulting in a computer network metrics summary. The computer network metrics summary includes at least a portion of the processed device data and the processed facility data. In addition, the sustainability module is configured to update the system database using the computer network metrics summary and transmit the computer network metrics summary to the user interface. The user interface is configured to allow a determination of a sustainability adjustment to the computer and the plurality of computer network devices based, at least in part, on the computer metrics summary, and apply the sustainability adjustment to the computer and the plurality of computer network devices. Applying the sustainability adjustment optimizes the power usage of the plurality of computer network devices.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 depicts a system in accordance with one or more embodiments.

FIG. 2 depicts a system in accordance with one or more embodiments.

FIG. 3 depicts a flowchart in accordance with one or more embodiments.

FIG. 4 depicts a flowchart in accordance with one or more embodiments.

FIG. 5 depicts a neural network in accordance with one or more embodiments.

FIGS. 6A and 6B depict recurrent neural networks in accordance with one or more embodiments.

FIG. 6C depicts a long short-term memory network in accordance with one or more embodiments.

FIG. 7 depicts a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a “renewable energy facility,” may include any number of “renewable energy facilities,” without limitation.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

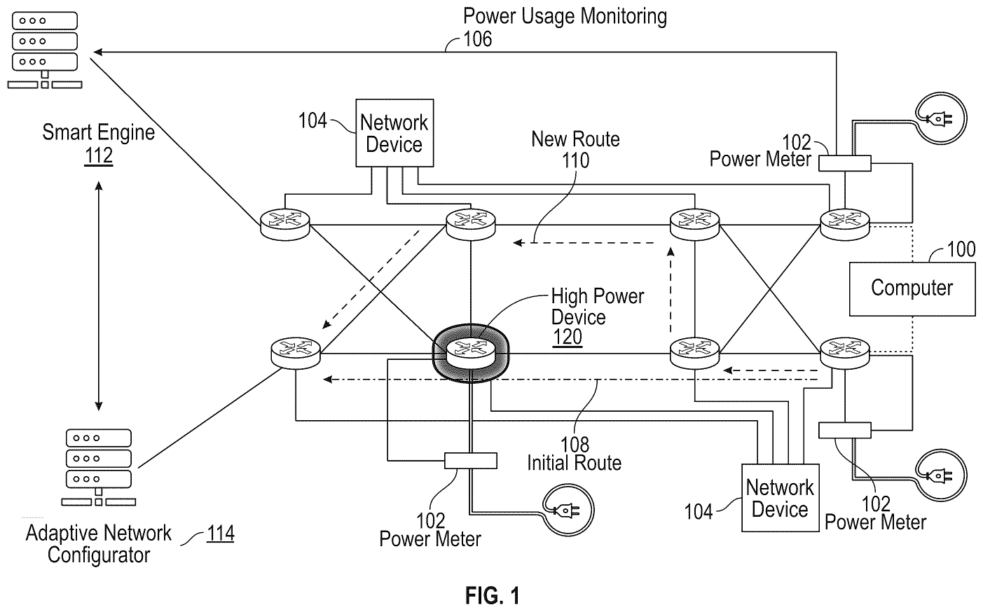

In the following description of FIGS. 1-7, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

In general, embodiments of the disclosure include systems and methods for sustainably operating computer network equipment. A computer network facility may house computer network equipment including at least one computer and a plurality of computer network devices. Throughout the present disclosure, a computer network device refers to devices that are communicatively linked or coupled to computers or that serve to provide communicative links between one computer and another. Examples of computer network devices may be a router and an internet modem. The router may create a local area network for any computer in the computer network facility while also providing a communicative link to the modem thereby providing a connection to the global internet as made possible by an internet service provider. The computer and the plurality of computer network devices may be communicatively coupled to one another and exchange network data. Generally, the network data may include standard data packets used for transmission of information between computers connected to the internet. However, the network data may also include data specific to the computer network facility. For example, a computer network facility located at an oil and gas processing plant may transmit measurements from the oil and gas processing plan related to pressures, temperatures, and flow rates throughout the processing plant in the form of network data.

The computer and the plurality of computer network devices may be communicatively coupled to a system database capable of storing various forms of data received from the computer network facility as well as from the computer and the plurality of computer network devices. At a minimum, the system database is configured to receive data from the plurality of computer network devices including a power usage of the plurality of computer network devices. The system database may itself be communicatively coupled to a user interface allowing for a user to interact with the computer and the plurality of computer network devices.

Both the user interface and the system database may be communicatively coupled to a sustainability module. The sustainability module is used to process data obtained from the computer network facility, the computer, and the plurality of computer network devices and provides several capabilities to the system related to sustainable operation that will be described in greater detail below. In short, the sustainability module processes data obtained from the computer network facility and from the computer and plurality of network devices to create a computer network metrics summary comprising at least a portion of the processed data. The computer network summary may be used to update the system database and may be transmitted to the user interface. By using the user interface, a sustainability adjustment may be determined based, at least in part, on the computer metrics summary. In addition, the user interface may be used to apply the sustainability adjustment to the computer and the plurality of computer network devices such that the power usage of the computer and the plurality of computer network devices is optimized.

In one or more embodiments, the sustainability adjustment may also change the transmission of the network data between the computer and the plurality of computer network devices. For example, to optimize the power usage of the computer and the plurality of computer network devices, the sustainability adjustment may selectively change which of the plurality of computer network devices the computer transmits network data to. In some embodiments, the sustainability adjustment changes the transmission of the network data between the computer and the plurality of computer network devices while maintaining a communication link between the computer and at least one of the plurality of computer network devices. In this way, the sustainability adjustment is ensured to not disrupt the stability of the computer network supported by the computer and the plurality of computer network devices.

In one or more embodiments, processing the device data and the facility data using the sustainability module includes creating a device profile for each of the plurality of computer network devices, resulting in a plurality of device profiles. A device profile for a particular computer network device may be a digital representation or model of the computer network device, including a record of its past power usage, a prediction of its future power usage, and a real-time measurement of its current power usage. In addition, processing the device data and the facility data using the sustainability module may further include creating a plurality of routing profiles for the transmission of network data between the computer and the plurality of computer network devices. A routing profile may define a particular network data transmission pathway for the transmission of network data between the computer and the plurality of computer network devices based, at least in part, on the device data and the facility data. Alternatively, or in addition, a routing profile may define a set of rules for transmitting network data between the computer and the plurality of computer network devices.

In one or more embodiments, the computer network metrics summary is created based on the plurality of device profiles and the plurality of routing profiles and the sustainability adjustment is applied to the computer and the plurality of computer network devices automatically. The device profiles may describe past, present, and future power usage of each of the plurality of computer network devices. In addition, the routing profiles may prescribe pathways for the transmission of network data under different power usage scenarios. Accordingly, with the computer network metrics summary created based on the plurality of device profiles and the plurality of routing profiles, it may be possible to allow the system to operate without human intervention. The system may respond automatically (i.e., on short time scales of seconds, every minute, every hour, up to and including every several hours) to continuously optimize the power usage of the plurality of network devices. In one or more embodiments, a user would not need to use the user interface to optimize the power usage of the plurality of computer network device but could monitor changes in the system through analyzing the computer metrics summary that is transmitted to the user interface.

In one or more embodiments, the sustainability module may include a smart engine that uses at least one machine learning model to process the device data and the facility data. Greater description of machine learning models will be given below. As a non-limiting example, the at least one machine learning model may be used to assist in the creation of the either the device profiles, the routing profiles, or both. Alternatively, or in addition, the sustainability module may include an anomaly detector configured to determine an anomaly based on the device data and the facility data and report the anomaly to the user interface. The anomaly detector may itself use at least one or more machine learning models to detect anomalies, such as excessive power usages of one or more of the plurality of computer network devices.

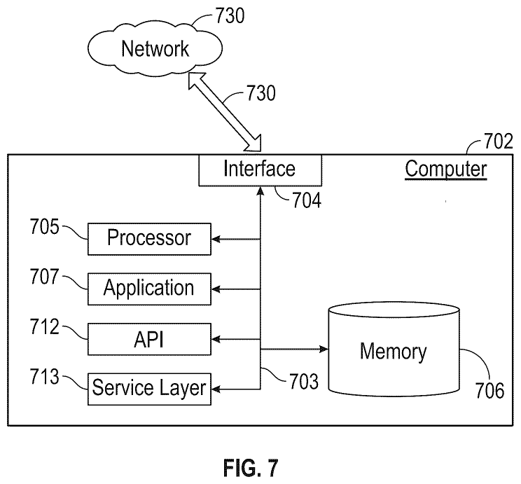

FIG. 1 depicts a schematic diagram in accordance with one or more embodiments. More specifically, FIG. 1 depicts a schematic diagram of a computer (100) connected to a plurality of devices. The computer may be located anywhere in which a computer network is operated. For example, a computer (100) may be located within a high-performance computing center, a research laboratory, an oil and gas processing plant, or an individual's home, or in another setting where a computer network is used for a particular purpose. A computer network, in each instance, refers to a system that connects one or more computing devices, such as a computer (100). The computer (100) may be similar to the computer that is described in relation to FIG. 7 below. The computer (100) may be connected to a plurality of computer network devices (104). A computer network device refers to a device that supports, maintains, or otherwise participates in a computer network. For example, a computer network device (104) may be an internet modem that provides access to the global internet through an internet service provider. A computer network device (104) may also be an internet router which connects local devices, through a local area network, to the global internet through communication with a modem. Computer network devices (104) also include additional computers (100), repeaters (wireless range extenders or boosters), servers which provide services to other computers in the network (i.e., clients), and shared devices such as printers or storage devices with access to the computer network.

At least two computer network devices (104) may be communicatively coupled to the computer (100), although there is no maximum limit to the number of computer network devices (104) that are communicatively coupled to the computer (100). Each of the plurality of computer network devices (104) may be communicatively coupled to the other computer network devices (104) as well, or they may be connected to only a subset of the plurality of computer network devices (104). For example, in some embodiments, a single computer network device (104) may be communicatively coupled to only one or two other computer network devices (104). Communicatively coupling one device to another may include establishing communication links between the devices using the computer network, either through a wired connection or wireless connection (e.g., Wi-Fi or Bluetooth). The information exchanged between a computer (100) and a computer network device (104) may be referred to as network data. Network data can include several types of information or data structures that can be transmitted over a computer network. For example, network data may include data files containing text, image data, or audio data as well as queries, requests, or commands.

One or more of the computer network devices (104) may be equipped with a power meter (102). A power meter (102) records the power usage of the computer network device (104) that it is connected to. In some embodiments, one or more of the computer network devices (104) may be equipped with sensors that measure additional qualities of the computer (100) and computer network devices (104), such as device temperature. In embodiments that use routers or signal repeaters as computer network devices (104), one or more computer network devices (104) may include a sensor to measure the amount of network data, or the network data “traffic,” that is transmitted through the respective computer network device (104). The measurements of various properties of the devices, such as the device power usage, temperature, or traffic, may be collectively referred to as device data.

To review, at least two distinct types of data may be utilized according to the methods and systems of the present disclosure. The data types include network data, which includes information exchanged between the computer (100) and the computer network devices (104), and device data, which primarily relates to the status of each of the computer (100) and plurality of computer network devices (104), where the status may include a power usage, a temperature, an amount of network traffic (e.g., a real-time or time-averaged amount of network data transmission).

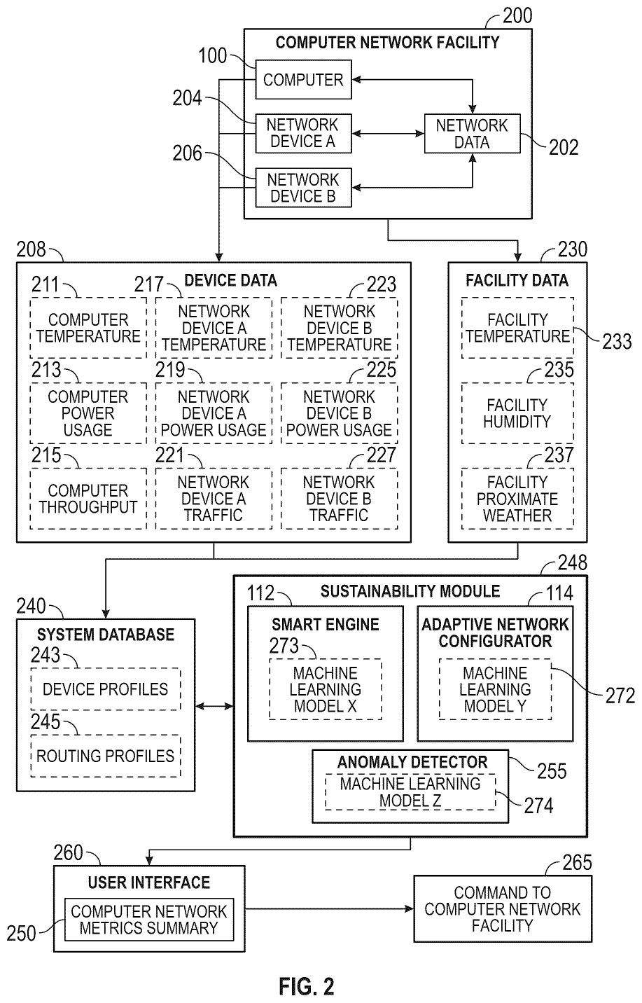

As the computer (100) and plurality of computer network devices (104) exchange network data over time, the device data of each of the computer (100) and the plurality of computer network devices (104) is likely to change. That is, depending on the amount of network data that is transmitted, or the rate at which network data is transmitted, the power usage, temperature, and amount of network traffic that occurs to the computer (100) and plurality of computer network devices (104) will vary thus changing the measured device data. In some cases, environmental factors may contribute to changes in the device data. In order to maintain a record of device data and to predict future changes in device data, one or more of the computer (100) or plurality of computer network devices (104) may transmit the device data to a smart engine (112). A smart engine (112) is a system that may be used to monitor the device data gathered from the computer network, or more specifically, from the computer (100) and plurality of computer network devices (104), as well as make predictions of future changes in device data. The smart engine (112) is described further below in relation to FIG. 2. Staying with FIG. 1, the smart engine (112) is depicted in FIG. 1 as monitoring the device data by carrying out power usage monitoring (106). In this non-limiting example, the device data includes power usage as measured by one of the power meters (102). By continuously carrying out power usage monitoring (106), the smart engine (112) can be used to track the history of power usage from one or more of the computer network devices (104) and thus predict future changes in power usage based on the past behavior.

Maintaining a record of device data and predicting changes in device data, as provided by the smart engine (112) may be useful in both maintaining the longevity of the computer network equipment such as the computer (100) or one of the computer network devices (104). In addition, the historical record of device data and predictions of future changes in device data from the smart engine (112) may be used to maximize the energy efficiency and network throughput of the computer network. In order to make use of the output of the smart engine (112), an adaptive network configurator (114) may be used. An adaptive network configurator (114) is a system that is operationally coupled to the computer network and that communicates with the smart engine (112) in order to enact changes to the computer network. Accordingly, the adaptive network configurator (114) is capable of changing both the physical and logical paths of computer network by assigning a routing profile, or path for the flow of network data, to the computer network. The routing profile may be assigned by the adaptive network configurator (114) to the computer network by physically altering the computer network, for example, by turning on or off one or more of the plurality of computer network devices (104) to create a new network topology. Alternatively, or in addition, the routing profile may be assigned by the adaptive network configurator (114) to the computer network by selectively determining how network data is transmitted to and from one or more of the plurality of computer network devices (104), for example, by throttling the network traffic or increasing the allowed network traffic to one or more of the plurality of computer network devices (104). Greater detail regarding the adaptive network configurator (114) is provided in relation to FIG. 2.

FIG. 1 includes a depiction of a non-limiting example of utilizing the smart engine (112) and adaptive network configurator (114) improve the longevity of the computer network equipment and increase energy efficiency of the computer network. In this example, the computer network is configured to transmit network data from the computer (100) through a subset of the plurality of computer network devices (104) along an initial route (108). Meanwhile, the smart engine is conducting power usage monitoring (106) from one or more of the power meters (102) associated with the computer network devices (104). By doing so, the smart engine (112) may determine that one of the one of the plurality of computer network devices (104) is a “high power device” (120). A high-power device (120) is a computer network device (104) that utilizes a significant amount of power. A high-power device (120) is likely to be both inefficient in the usage of energy and likely to experience a physical malfunction by operating in an extreme state.

A computer network device (104) may be identified as a high-power device (120) by the smart engine in many ways. As previously mentioned a computer network device (104) may be a Wi-Fi router. On average, Wi-Fi routers utilize between 2-20 watts. However, specialized routers that connect many devices, use multiple antennae for data transmission, or support virtual private networks (VPNs) may utilize more power. In addition, environmental factors, such as heat, can contribute to the power usage of a Wi-Fi router by increasing the amount of cooling that is needed. Continuing with the example of a Wi-Fi router as a computer network device (104), the smart engine (112) may label the Wi-Fi router as a high-power device (120) if its power usage exceeds a predetermined threshold. The predetermined power threshold may be a static value that does not change with time, for example, 20 or 25 watts. Alternatively, or in addition, the predetermined threshold may be a relative value that changes in time and is determined relative to a past power usage or a predicted power usage in the future. In such cases, the predetermined threshold may be 150% (or another value, such as 200%) of the past average power usage or the predicted future power usage. A person of ordinary skill in the art will appreciate that additional predetermined thresholds may be used in order to maintain the longevity and energy efficiency of the computer network.

Continuing with the example of FIG. 1, the smart engine (112) may identify a computer network device (104) as a high-power device (120) and inform the adaptive network configurator (114). In addition to informing the adaptive network configurator (114) about the presence of a high-power device (120), the smart engine (112) may also transmit the historical records of power usage from the computer network and predictions of future power usage. In response, the adaptive network configurator (114) may enact a change in the computer network and cease the transmission of network data through the initial route (108). Instead, a new route (110) for network data transmission may be specified by the adaptive network configurator (114) and applied to the computer network. The new route (110), in this example, stops utilizing the high-power device (120) in order to allow the high-power device (120) to return to a safe operating state and to improve the energy usage of the entire computer network.

A person of ordinary skill in the art will recognize that the above example is illustrative of only one or more embodiments of the methods and systems of the present disclosure. In some cases, the smart engine (112) need not identify any computer network device (104) as a high-power device (120). Instead, the smart engine (112) may determine one or more computer network devices (104) are operating within safe power usages but the adaptive network configurator (114) may nonetheless determine a change to the transmission of network data through the computer network to utilize even less energy. Thus, in some embodiments, the smart engine (112) and adaptive network configurator (114) may work continuously together to maintain the computer network in an optimal state.

In one aspect, embodiments disclosed herein relate to methods and systems related to operating computer network equipment. FIG. 2 depicts schematic illustration of such a system, in accordance with one or more embodiments. It is to be understood that the embodiments represented by FIGS. 1 and 2 are not necessarily identical. However, like elements are present in both and thus are referred to using the same labels.

FIG. 2 includes a computer network facility (200). A computer network facility (200) refers to a location in which a computer network is operated, for example a high-performance computing center, a research laboratory, an oil and gas processing plant, a business center, or an individual's home. The computer network facility (200) includes a computer (100) and a plurality of computer network devices. In this way, it may be said that the computer network facility (200) houses the computer network or the computer network equipment. For clarity, the plurality of computer network devices are referred to individually as network device A (204) and network device B (206). However, it is to be understood that network device A (204) and network device B (206) are substantially similar to the plurality of computer network devices of FIG. 1. That is, network device A (204) and network device B (204) device that supports, maintains, or otherwise participates in a computer network, such as an internet modem, an internet router, an additional computer, a repeater, a server, or a shared device such as a printer or storage device with access to the computer network. In addition, it is to be understood that network device A (204) need not be the same type of computer network device as network device B (206), although in some embodiments network device A (204) may be the same type of computer network device as network device B (206).

The computer (100) and computer network devices (e.g., computer network device A (204) and computer network device B (206)) are communicatively coupled and transmit to one another network data (202). As described in reference to FIG. 1, network data (202) may include any properly formatted data capable of being transmitted through a computer network. For example, network data (202) may include data files containing text, image data, or audio data as well as queries, requests, or commands. Mention how the different numbers of network devices allow for different paths of network data transmission.

The computer network facility (200) may include any number of computer network devices, where the minimum number of computer network devices is two. Thus, although only two computer network devices are depicted (i.e., network device A (204) and network device B (206)) embodiments of the present disclosure may be applied to computer networks with additional computer network devices. By including at least two computer network devices, the computer network may be more distributed and thus the energy output of one device in the computer network is lowered. For example, if only one computer network device (e.g., network device A (204)) is used to support the computer network, then the entirety of the network data (202) must be transmitted or processed through the sole computer network device (e.g., network device A (204)). By including an additional computer network device (e.g., network device B (206)), each network device need only process or transmit approximately half of the network data (202).

A computer network supported by only one computer (e.g., computer (100)) and one computer network device (e.g., network device A (204)) can only support a simple computer network topology. Network topology refers to the arrangement of computers or computer network devices operating together in a computer network and is defined by the physical and digital pathways that communicatively couple the members of the computer network. Network topology is often defined in terms of both the “physical” topology, which describes the physical arrangement, hardware, and connections between members of the computer network, as well as “logical” topology which describes how network data (202) is transmitted throughout the computer network. For example, in a computer network with one computer and four computer network devices, the physical topology is defined by the arrangement of computer and four computer network devices and their physical connections. The logical topology is defined by the pathways between the computer and four computer network devices in which network data (202) is transmitted. To this end, “virtual” networks are sometimes used, which partition the transmission of network data (202) between subsets of the members of the computer network.

With only a computer (e.g., computer (100)) and one computer network device (e.g., computer network device A (204)), the only possible network topology is a “point-to-point” topology in which the computer (e.g., computer (100)) sends network data (202) directly to the network device (e.g., computer network device A (204)). As described above, such a simple arrangement offers no flexibility for power usage and requires each member of the network to operate constantly.

Including a computer and number of computer network devices greater than two allows for more complicated network topologies. For example, with a computer (e.g., computer (100)) and at least two computer network devices (e.g., network device A (204) and network device B (206)), a “mesh” topology is possible. In a mesh network topology, the computer (e.g., computer (100)) and the computer network devices (e.g., network device A (204) and network device B (206)) are each connected to every other device. A mesh topology allows for both stable and fast transfer of network data (202) throughout the computer network. An alternative network topology is a “star” topology. In a star network topology, one device serves a central role and every other device is connected to the center device. Star networks are flexible and simple to operate because only one device, the center device, governs the transmission of network data (202) throughout the computer network. Additional examples of network topologies include a “bus” topology where, after a starting member, which may be a computer (e.g., computer (100)), the subsequent computer network devices are connected to each other, one after the other, in a line. To transmit data from the computer, in this example, to the final computer network device, the data must travel through every interceding computer network device. Bus topologies are simple to construct, maintain, and expand. Similar to a bus topology is a “ring” topology, which is the same as a bus topology except the final device is also connected to the first, forming a loop. Another network topology is a “tree” network topology. A tree network topology begins similar to a star network topology with a central device. Additional devices are connected to the central device and may be referred to as branch devices. Branch devices may have leaf devices connected thereto. Tree topologies are useful for physically separating certain computer network devices from others. Lastly, “hybrid” computer network devices” which connect computers and computer network devices using multiple types of individual network topologies.

Each type of computer network device has distinct advantages and disadvantages. Generally, more complex computer network topologies are more difficult to construct and require greater maintenance while simpler network topologies are easily maintained and do not require significant resources to build. On the other hand, complex computer network topologies can provide greater flexibility, enhanced stability, and improved data transfer rates compared to simpler topologies. A person of ordinary skill in the art will recognize that additional advantages and disadvantages not discussed above are exhibited by the different types of computer network topologies.

As previously stated, it is to be understood that embodiments of the present disclosure are not limited to systems or methods employing only one computer (e.g., computer (100)) and two computer network devices (e.g., computer network device A (204) and computer network device B (206)). In addition, embodiments of the present disclosure are not limited to computer networks that use only one computer (e.g., computer (100)) and two computer network devices (e.g., computer network device A (204) and computer network device B (206)), or computer network topologies that only use one computer (e.g., computer (100)) and two computer network devices (e.g., computer network device A (204) and computer network device B (206)). Embodiments of the present disclosure include computer networks and computer network topologies without limit to the number of computers or computer network devices involved. Thus, although only one computer (i.e., computer (100)) and two computer network devices (i.e., network device A (204) and network device B (206) is depicted) are depicted in FIG. 2, network topologies involving additional members are included by embodiments of the present disclosure.

In one aspect, embodiments of the present disclosure are directed to improving the longevity of the equipment used in operating a computer network and to lower or optimize the power usage of the equipment utilized to operate the computer network. Both the longevity of the members of a computer network and their energy usage will be affected by the status of each of the members and also aspects of the facility in which the members of the computer network operate. To this end, and continuing with FIG. 2, the members of the computer network (e.g., computer (100), network device A (204) and network device B (206)) operate and transmit network data (202) to one another. At the same time, device data (208) is obtained from each of the members of the computer network, and facility data (230) is obtained from the computer network facility (200). The device data (208) and facility data (230) are ultimately used to determine an adjustment to the operational state of the members of the computer network and optionally to the computer network facility (200) that improves the longevity of the members of the computer network and their power usage.

As described in reference to FIG. 1, device data (208) may include device power usage, device temperature, device network traffic, or additional properties relating the status of each of the members of the computer network. For example, in FIG. 2, the device data (208) includes a computer temperature (211) which is the temperature of the computer (100), computer power usage (213) which is the power usage of the computer (100), and computer throughput (215) which is the amount of network data (202) being generated or transmitted from the computer (100). This example assumes that the computer (100) serves a central role in the computer network, although this need not be the case. Similarly, the device data (208) may include network device A temperature (217), network device A power usage (219), network device A traffic (221), network device B temperature (223), network device B power usage (225), and network device B traffic (227) . . . . In this example, it is assumed that neither network device A (204) nor network device B (206) are the central device in the network topology, and hence the amount of network data (202) that is transmitted therethrough is referred to as “traffic” rather than “throughput” as it is for the computer (100). It is to be understood that this distinction is made only for the sake of clarity and that embodiments of the present disclosure are not limited by a specific network topology or label for the amount of network data (202) that a specific member of the network topology processes or transmits. In addition, a person of ordinary skill in the art will appreciate that other examples of device data (208) are within the scope of the present disclosure. For example the device data (208) may also include device humidity, the age of each device, or the amount of time the device has been running without being turned off, among other possibilities.

In one or more embodiments, the computer (100), computer network device A (204), and computer network device B (206) are each configured to measure or obtain their own device data (208). In other embodiments, each member of the computer device may also be connected to a specialized sensor for measuring device data (208). For example, in FIG. 1, the computer network devices (104) are depicted connected to power meters (102) which measure power usage. Members of the computer network may also be connected to digital thermometers. Network traffic or throughput may be measured using specific software and firmware installed on each of the members of the computer network. Additional types of device data (208), such as device humidity, may require additional sensors (e.g., a humidity sensor) to provide the necessary device data (208).

Facility data (230) refers to aspects of the computer network facility (200) that may impact either the status of the members of the computer network, such as the computer (100), network device A (204), and network device B (206). Examples of facility data may include facility temperature (233). If the facility temperature (233) is high, then this may increase the computer temperature (211), network device A temperature (217), and network device B temperature (223). In addition, a high facility temperature (233) may increase the computer power usage (213), network device A power usage (219) and network device B power usage (225). This is because most modern computers and computer network devices include built-in fans or other cooling systems which typically turn on automatically to help maintain a safe temperature. Additional examples of facility data (230) may include facility humidity (235), which may also pose a risk to the longevity or energy usage of the members of the computer network, and facility proximate weather (237). Facility proximate weather (237) may include measurements of the local weather or weather forecasts. For example, facility proximate weather (237) may include a measurement of an a temperature outside the computer network facility (200) or other weather even that could affect the members of the computer network.

Both the device data (208) and facility data (230) may be transmitted by one or more members of the computer network (e.g., one or more of the computer (100), network device A (204), and network device B (206)) to a system database (240). In some embodiments, each of the computer (100), network device A (204), and network device B (206) may transmit device data (208) to the system database (240). The system database maintains a record of device data (208) and facility data (230) over time. The system database (240) may itself be a computer network device communicatively coupled to the computer network.

In accordance with one or more embodiments, the system database (240) may be communicatively coupled to a sustainability module (248). The sustainability module (248) is a system that includes both hardware and software designed to improve the longevity of members of a computer network and to improve or optimize their power usage. The sustainability module (248) may itself be a computer or a computer network device. The system database (240) transmits the device data (208) and facility data (230) to the sustainability module (248) which processes the device data (208) and facility data (230).

Processing the device data (208) and the facility data (230) results in a computer network metrics summary (250). In one aspect, the computer metrics summary (250) may be representative of significant aspects of the computer network. For example, the computer network metrics summary (250) may include at least a portion of the processed device data (208) and facility data (230). Alternatively, or in addition, the computer network metrics summary (250) may include a condensed representation of the processed device data (208) and processed facility data (230). For example, the computer network metrics summary (250) may include a measurement of the average (or median) computer temperature (211) over time, or the spread (or standard deviation) of computer temperatures (211) that have been measured as part of the device data (208). As another example, the computer network metrics summary (250) may include an estimate or prediction of a future state of device data (208), for example, a future computer temperature (211). This estimate may be made based on the processed device data (208) and may be obtained by measuring a discrete derivative of the record of computer temperatures (211) stored in the system database (240). Alternatively, or in addition, the future computer temperature (211) may be determined by fitting a mathematical function to the record of computer temperatures (211) stored in the system database. The same applies to the facility data (230) as well as every other aspect of the device data (208). Thus, the computer network metrics summary (250) may include a portion or a condensed representation of the processed facility data (230) or the processed device data (208) for any of the devices in the computer network (e.g., computer (100)), computer network device A (204), computer network device B (206)).

In one or more embodiments, the computer network metrics summary is used to update the system database (240). Thus, while the system database (240) obtains a record of device data (208) and facility data (230), the sustainability module (248) may be used to process the device data (208) and facility data (230) to obtain the computer network metrics summary (250). As described above, the computer network metrics summary (250) may include a portion of the processed device data (208) and processed facility data (230), or a condensed representation of the processed device data (208) and processed facility data (230). Then, the system database (240) may be used to store a record of computer network metric summaries (250), in addition to records of device data (208) and facility data (230).

In accordance with one or more embodiments, the computer network metrics summary may be transmitted to a user interface (260). The user interface (260) is generally used to monitor and interact with the computer network as it operates. For example, the user interface (260) may provide comprehensive visualization of the computer network metrics summary (250), including interactive graphs, charts, and real-time. As the computer network metrics summary (250) summarizes the status of every member of the computer network, the user interface (260) may be used to view investigate the status of each component of the computer network in a centralized platform. The user interface (260) may be customized to allow users to tailor the display according to their specific needs and preferences, including setting thresholds for alerts, choosing which aspects of the computer network metrics summary (250) to display prominently, and customizing the layout for optimal usability. In one or more embodiments, the computer network metrics summary (250) may highlight certain devices as exhibiting a problem, for example exhibiting a high power usage or extreme temperature. The user interface (260) may thus be used to obtain real-time monitoring and immediate alerts for any deviations from optimal environmental conditions, ensuring quick responses to issues like overheating or high power consumption. In one or more embodiments, the computer network metrics summary (250) may be transmitted to the user interface as well as the full history of the device data (208) and facility data (230) that has been obtained by the system database (240). In such cases, the user interface may support historical data analysis and includes tools for analyzing historical device data (208) and facility data (230) in real time or “on the fly.”

In one or more embodiments, processing the device data (208) and the facility data using the sustainability module (248) includes creating a device profile each of the members of the computer network (e.g., computer (100)), computer network device A (204), computer network device B (206)), resulting in a plurality of device profiles (243). A device profile for a particular computer network device may be a digital representation or model of the computer network device. In one aspect, a device profile is an organizational structure used to isolate and record the past status of computer network device, predictions of its future status, and a real-time measurement of its current status, where in each case the status is defined by the device data (208). For example, the device profile of the network device A (204) may include a record of network device A power usage (219), different predictions for future network device A power usage (219), and the current network device A power usage (219).

The smart engine may determine the device profile of a single device while considering the facility data (230) and the device data (208) from multiple members of the computer network (e.g., computer (100)), computer network device A (204), computer network device B (206)) simultaneously. In this way, the device profiles may capture the covariant relationships between members of the computer network (e.g., computer (100)), computer network device A (204), computer network device B (206)) and the computer network facility (200). For example, the device profile of network device A (204) may be informed by both the device data (208) for network device A (204) and network device B (206) such that predictions in the future network device A power usage (219) are informed by the past, present, and predictions of future network device B power usage (225).

In one or more embodiments, processing the device data (208) and the facility data (230) using the sustainability module (248) may include creating a plurality of routing profiles (245) for the transmission of network data between the members of the computer network (e.g., computer (100)), computer network device A (204), computer network device B (206)). A routing profile may define a particular network data (202) transmission pathway for the transmission of network data (202) between the members of the computer network (e.g., computer (100)), computer network device A (204), computer network device B (206)) based, at least in part, on the processed device data (208) and the processed facility data (230). Put differently, a routine profile may define a computer network topology for the member of the computer network (e.g., computer (100)), computer network device A (204), computer network device B (206)). Alternatively, or in addition, a routing profile may define a set of rules for transmitting network data between the computer and the plurality of computer network devices, or a set of rules for changing the computer network topology. For example, a first routing profile may define a first network topology to use when each member of the computer network (e.g., computer (100)), computer network device A (204), computer network device B (206)) is operating normally. However, if one or more members of the computer network (e.g., computer (100)), computer network device A (204), computer network device B (206)) deviates, for example, in power usage, then a second routing profile may define a second network topology to use.

Both the device profiles (243) and routing profiles (245) may be informed by each other. That is, the device profiles (243) may include predictions of future states of members of the computer network (e.g., computer (100)), computer network device A (204), computer network device B (206)) according to different routing profiles (245). Similarly, different routing profiles (245) may be determined based on different predicted states of the members of the computer network (e.g., computer (100)), computer network device A (204), computer network device B (206)) according to the device profiles (243).

In one or more embodiments, the computer network metrics summary (250) is created based on the plurality of device profiles (243) and the plurality of routing profiles (245). In such embodiments, updating the system database (240) using the computer network metrics summary (250) may include storing the device profiles (243) and routing profiles (245) on the system database (240). In some embodiments, the computer network metrics summary (250) includes the device profiles (243) and the routing profiles (245).

By using the user interface (260), a sustainability adjustment may be determined based, at least in part, on the computer metrics summary (250). The sustainability adjustment defines a change to the operation of the members of the computer network (e.g., computer (100), network device A (204), and network device B (206)) and optionally to the computer network facility (200). The sustainability adjustment improves the longevity at least one of the members of the computer network (e.g., computer (100), network device A (204), and network device B (206)) or improves or optimizes the power usage of the members of the computer network (e.g., computer (100), network device A (204), and network device B (206)). In one or more embodiments, the sustainability adjustment may also change the transmission of the network data (202) between the members of the computer network (e.g., computer (100), network device A (204), and network device B (206)). Such a change may be referred to as a change to the computer network topology, as discussed above. For example, to optimize the power usage of the computer (100), network device A (204), or network device B (206), the sustainability adjustment may selectively adapt the network topology. In one or more embodiments, the sustainability adjustment may change the transmission of the network data (202) between the members of the computer network (e.g., computer (100), network device A (204), and network device B (206)) while maintaining a communication link between the members of the computer network (e.g., computer (100), network device A (204), and network device B (206)). In this way, the sustainability adjustment is ensured to not disrupt the stability of the computer network.

The user interface (260) may also be used to apply the sustainability adjustment to the members of the computer network (e.g., computer (100), network device A (204), and network device B (206)). That is, the user interface (260) may be used to send a command to the computer network facility (265) to enact the sustainability adjustment. A user may select or determine the sustainability adjustment based on the computer network metrics summary (250) and their professional experience and background knowledge regarding computer networks. However, in one or more embodiments, the sustainability adjustment may be determined automatically based on the computer network metrics summary (250) using an optimization routine. In such embodiments, the command to the computer network facility (265) may also be sent automatically, or a user may select when to transmit the command to the computer network facility (265). Systems of the present disclosure may operate automatically (i.e., on short time scales of seconds, every minute, every hour, up to and including every several hours) to continuously optimize the power usage of the members of the computer network (e.g., computer (100), network device A (204), and network device B (206)). In one or more embodiments, a user would not need to use the user interface (260) to optimize the power usage of the plurality of computer network device but could monitor changes in the system through analyzing the computer network metrics summary (250) that is transmitted to the user interface (260).

In accordance with one or more embodiments, an optimization algorithm or method is used to invert, or intelligently probe the computer network metrics summary such that the sustainability adjustment optimizes an aspect of the computer network, such as a power usage of one or more of the members of the computer network (e.g., computer (100), network device A (204), and network device B (206)). A person of ordinary skill in the art will appreciate that the description provided herein is applicable to many aspects of the computer network. However, as an illustrative, example, power usage will be considered. In particular, power usage of a plurality of computer network devices (e.g., network device A (204), and network device B (206)) will be considered.

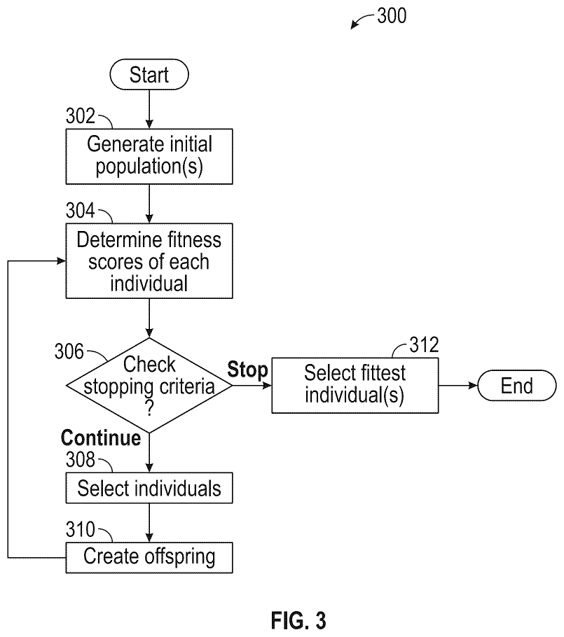

A commonly used non-linear optimizer is the genetic algorithm (GA). An overview of the typical steps used in the genetic algorithm (GA) is provided in FIG. 3. The genetic algorithm (300) begins by generating an initial population or multiple populations (302). A population consists of one or more “individuals.” In the context of the genetic algorithm (300), an individual is a single representation, or encoding, of the function parameters over which optimization is to occur. In the case of optimizing the power usage of a plurality of computer network devices (e.g., network device A (204), and network device B (206)), the function may be considered the computer network metrics summary (250) which provides predictions of various outputs in the form of power usages according to the operating states of the members of the computer network (e.g., computer (100), network device A (204), and network device B (206)) and computer network facility (200). Thus, a parameter to consider in the optimization of power usage from the plurality of computer network devices (e.g., network device A (204), and network device B (206)) is the network topology, and optionally the configurable parameters of the computer network facility, if they are present, such as the facility temperature (233). In this case, an individual is the assignment of values to each parameter (e.g., a particular network topology and a particular facility temperature (233)) while respecting any imposed constraints (e.g., not permitting the facility temperature to exceed a predetermined limit, or not permitting the network topology to produce an inoperable topology with a missing connection). The number of individuals in a population, and the method of initially generating individuals, are hyperparameters chosen by the user. When multiple populations are used, commonly referred to as an “island” scheme, the populations need not be initialized using the same set of hyperparameters.

Once a population(s) has been generated (302), the “fitness” of every individual in the population(s) is evaluated (304). Continuing from the example above, parameter values of an individual are used to assign a network topology and a facility temperature in order to determine a predicted power usage for the plurality of computer network devices (e.g., network device A (204), and network device B (206)). Because the goal is to minimize the predicted power usage for the plurality of computer network devices (e.g., network device A (204), and network device B (206)), individuals that result in lower predicted power usages are considered “more fit.”

Next, a stopping criterion is checked (306). Many stopping criteria exist, including, but not limited to, the number of iterations the genetic algorithm has run, the maximum or minimum fitness score achieved by an individual, the relative change in fitness scores between iterations, and the similarity of individuals in a population, or combinations of these criteria. If the algorithm is to stop, typically, the most fit individual(s) seen during the genetic algorithm process is selected (312) and the algorithm terminates. Likewise, if the genetic algorithm continues, one or more individuals from the population(s) are selected (308). This selection may be done by simply selecting the portion of the population with the highest fitness scores, or through a tournament process, or other selection mechanism.

Once individuals have been selected (308), the individuals may be propagated through without alteration, removed, or altered through so-called crossover, mutation, and differential evolution methods to create “offspring” (310). The offspring are themselves individuals; that is, new representations, or encodings, of the function parameters. It is noted that many evolutionary methods exist to create offspring and the preceding list is not all-inclusive and should be considered non-limiting. The offspring are then evaluated for fitness (304) and the process is repeated until the genetic algorithm stopping criterion is met. Continuing from the example above, once the stopping criterion is met, an optimal network topology and facility temperature is determined from the most fit offspring. The optimal network topology and facility temperature and used to determine the sustainability adjustment.

Again, the description of the genetic algorithm (GA) provided in FIG. 3 is generalized and one skilled in the art will appreciate that many modifications can be made, and are regularly made, to the genetic algorithm (GA) without departing from its intended scope. For example, an enhanced genetic algorithm (eGA) is developed by including additional features such as: enforcing deliberately diverse initial populations; using heterogenous hyperparameters for each population; dynamically updating or scheduling changes to the selection process and offspring creation process; using a unidirectional migration policy between populations; adding additional checks, such as a premature convergence check; using a self-adaptive differential evolution method; performing a localized exhaustive search in regions of stagnation or saturation. Other non-linear optimizers may be employed. The non-linear optimizer could be a Bayesian-based optimizer which elects new parameters based on an analysis of the updated posterior distribution. In this context, the level of exploration and exploitation would be determined by the user.

In some embodiments, the sustainability adjustment determined as a result of applying the optimization routine to the computer network metrics summary are validated by measuring the power usage from the plurality of computer network devices (e.g., network device A (204), and network device B (206)) and determining whether power usage is improved after applying the sustainability adjustment.

In some embodiments, the optimizer may consider multiple aspects of the computer network simultaneously during the optimization. For example, the optimizer may jointly minimize power usage while maximizing network traffic from a plurality of computer network devices (e.g., network device A (204), and network device B (206)). Accordingly, in one or more embodiments, the optimizer may seek the network topology and operational state of the computer network facility (200) that jointly achieves the maximum network traffic with the minimum power usage for the plurality of computer network devices (e.g., network device A (204), and network device B (206)). Mathematically, the optimization may take the form:

$${arg max}_{{S}_{1}} T + α P , \qquad ( 1 )$$

where the quantities T and P, representing the predicted device traffic and the predicted device power usage, respectively, are determined according the computer network metrics summary (250). In EQ. 1, the set of combinations of network topologies and possible states of the computer network facility (200) is denoted as S₁. EQ. 1 further makes uses of an optimization weighting factor (α). In EQ. 1, the optimization weighting factor is applied to the predicted power usage, however, this need not be the case. In some embodiments, the optimization weighting factor is applied to (as a product) the predicted network traffic. The optimization weighting factor serves, at least, two purposes. First, the optimization weighting factor acts to scale either the predicted network traffic or the predicted power usage (as shown in EQ. 1). Second, the optimization weighting factor weights either the predicted network traffic or the predicted power usage relative to the other output. In one or more embodiments, the optimization weighing factor is a predefined scalar such that the optimizer, returns a single and optimal sustainability adjustment. In other embodiments, the optimization weighting factor is an array such that the optimizer returns an array of optimal sustainability adjustments. In this case, the optimization weighting factor array and associated array of sustainability adjustments define a so-called Pareto front. One with ordinary skill in the art will appreciate that maximization and minimization may be made equivalent through simple techniques such as negation. As such, the choice to represent the optimization as a maximization as shown in EQ. 1 does not limit the scope of the present disclosure.

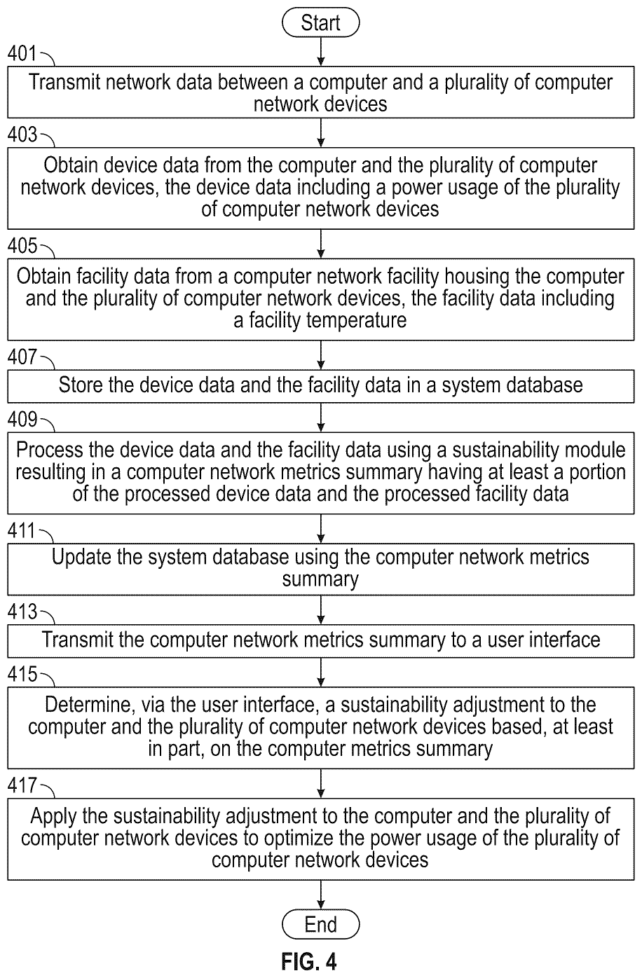

The process of determining and applying a sustainability adjustment that optimizes the power usage of the plurality of computer network devices is summarized in the flow chart of FIG. 4. In Block 401, network data may be transmitted between a computer and a plurality of computer network devices. The transmission of network data between the computer and the plurality of computer network devices forms a computer network with a computer network topology. The computer network topology defines the physical and logical pathways through which the computer and the plurality of computer network devices communicate. In Block 403, device data may be obtained from the computer and the plurality of computer network devices. The device data may include a power usage of the plurality of computer network devices. Additional examples of device data have been described above and include device temperature and device network traffic, among others not listed. In Block 405, facility data is obtained from a computer network housing the computer and the plurality of computer network devices. The facility data may include a facility temperature. Additional examples of facility data may include facility humidity and facility proximate weather, among others not listed. In Block 407, the device data and the facility data is stored in a system database. The system database is thus communicatively coupled to at least one of the computer and plurality of computer network devices.

In Block 409, the device data and the facility data is processed using a sustainability module resulting in a computer network metrics summary. The computer network metrics summary may include at least a portion of the processed device data and the processed facility data. Alternatively, or in addition, the computer network metrics summary may include a condensed representation of the processed device data and the processed facility data. In one aspect, the computer network metrics summary includes significant aspects of the processed device data and the processed facility data, where significance relates to its degree of correlation with power usage from the plurality of computer network devices. In Block 411, the system database may be updated using the computer network metrics summary. In this way, the system database not only stores the device data and the facility data but also the computer network metrics summaries that are created as the method is carried out. In Block 413, the computer network metrics summary may be transmitted to a user interface. The user interface allows for a user to interact with the computer network and monitor its status. In Block 415, a sustainability adjustment to the computer and the plurality of computer network devices may be determined using the user interface, based, at least in part, on the computer network metrics summary. The sustainability adjustment may be determined automatically or by a user. In Block 417, the sustainability adjustment may be applied to the computer and the plurality of computer network devices. Applying the sustainability adjustment may optimize the power usage of the plurality of computer network devices.

For example, in one or more embodiments, the framework disclosed herein ensures devices with lower power consumption and energy-efficient components are entrusted with a significant share of the network traffic load. Simultaneously, devices operating at full power capacity are relieved of excess traffic, reducing the risks of overheating and other adverse conditions. Thus, the computer network metrics summary may indicate which devices should have more load, and the sustainability adjustment may involve moving network traffic from a high energy network device to a lower one.

Embodiments of the present disclosure offer at least the following advantages. First, the user interface allows for comprehensive visualization to a complicated structure that is the computer network. Through visualization tools, including interactive graphs, charts, and real-time alerts for key environmental metrics such as power consumption, temperature, humidity, and facility settings, the user interface allows operators to intuitively engage with the system. Previous methods for operating computer networks often do not consider either the environmental impact on the computer network equipment, or the impact of the computer network equipment on the environment, for example, through excessive power consumption. The methods and systems of the present disclosure integrate data from various environmental sensors and network devices, allowing administrators to view and analyze the impact of environmental conditions on network performance in a centralized platform. Methods and systems of the present disclosure provide real-time monitoring and immediate alerts for any deviations from optimal environmental conditions, ensuring quick responses to issues like overheating or high power consumption.

In addition, methods and systems of the present disclosure enable analysis of historical data, helping administrators identify trends and make data-driven decisions to improve network sustainability and performance. Embodiments of the present disclosure utilize a holistic approach and considers multiple factors that relate to computer network degradation and environmental impact. The methods and systems allow for operation of complex computer networks that minimize energy consumption, balance traffic loads, and maintain ideal operating conditions for network devices. In addition, the methods and systems may be applied dynamically to apply sustainability adjustments based on real-time data to ensure continuous optimization.

A sophisticated routing engine is at the heart of the framework disclosed herein that dynamically adapts traffic flow through an intelligent topology. This approach minimizes electricity consumption, maintains optimal temperature and humidity conditions, and ensures the stability of network equipment. Leveraging data from an extensive database, including information on devices with low power consumption and environmental sensors, the framework continuously monitors network traffic and environmental metrics. It adeptly identifies opportunities to reduce power consumption and enhance environmental conditions. The result is a more eco-friendly and efficient network ecosystem that aligns seamlessly with the principles of sustainable innovation.

Returning to FIG. 2, the sustainability module (248) may process the data using a smart engine (112), an adaptive network configurator (114), and an anomaly detector (255). The smart engine (112) has been described briefly in reference to FIG. 1. To reiterate, the smart engine (112) is a system that may be used to monitor the device data (208) gathered from the computer (100), network device A (204), network device B (206), as well as make predictions of future changes in device data (208). The smart engine (112) may also monitor the facility data (230). In one or more embodiments, the smart engine (112) is used to process the device data (208) and the facility data (230) to create the device profiles (243). Alternatively, or in addition, the smart engine (112) may also be used to process the device data (208) and the facility data (230) to determine routing profiles (245). To accomplish these tasks, the smart engine (112) may make use of a machine learning model (e.g., machine learning model X (273)).

Machine learning, broadly defined, is the extraction of patterns and insights from data. The phrases “artificial intelligence”, “machine learning”, “deep learning”, and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term Machine learning (ML), will be adopted herein, however, one skilled in the art will recognize that the concepts and methods detailed hereafter are not limited by this choice of nomenclature.

Machine learning (ML) model types may include, but are not limited to, neural networks, random forests, generalized linear models, and Bayesian regression. ML model types are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. The selection of hyperparameters surrounding a model is referred to as selecting the model “architecture.” Generally, multiple model types and associated hyperparameters are tested and the model type and hyperparameters that yield the greatest predictive performance on a hold-out set of data is selected.

As noted, the objective of the smart engine (112), is to determine device profiles (243) and routing profiles (245) based on device data (208) and facility data (230). To reiterate, a device profiles may be a digital representation or model of the computer network device. In one aspect, a device profile may be thought of as a function for determining properties of the device. For example, a device profile may be thought of as a function for predicting the past and future power usage of a member of the computer network (e.g., computer (100)), computer network device A (204), computer network device B (206)). The future power usage of a member of the computer network (e.g., computer (100)), computer network device A (204), computer network device B (206)) may be a function of time, the network topology, the current and past state of the device according to the device data (208), and the current and past state of the facility data (230). As such, the smart engine may determine the device profile of a single device while considering the facility data (230) and the device data (208) from multiple members of the computer network (e.g., computer (100)), computer network device A (204), computer network device B (206)) simultaneously. In this way, the device profiles may capture the covariant relationships between members of the computer network (e.g., computer (100)), computer network device A (204), computer network device B (206)) and the computer network facility (200). For example, the device profile of network device A (204) may be informed by both the device data (208) for network device A (204) and network device B (206) such that predictions in the future network device A power usage (219) are informed by the past, present, and predictions of future network device B power usage (225). Accordingly, the hypothetical mathematical function that represents a device profile is highly complex and may be difficult to characterize analytically. However, machine learning models are excellent for approximating mathematical functions. Accordingly, the device profiles (243) may be determined using the smart engine (112) and a machine learning model (e.g., machine learning model X (273)).

Routing profiles (243) may be determined by the smart engine (112) using a machine learning model (e.g., machine learning model X (273)) using similar principles for creating the device profiles (243). To reiterate, a routing profile may define a particular network data (202) transmission pathway for the transmission of network data (202) between the members of the computer network (e.g., computer (100)), computer network device A (204), computer network device B (206)), a computer network topology, a set of rules for transmitting network data between the computer and the plurality of computer network devices, or a set of rules for changing the computer network topology. To optimize the longevity and power usage of the members of the computer network, the routing profiles (245) should preferably be informed by the device profiles (243) and vice versa. However, given the complexity described above involved in creating a device profile, determining routing profiles (245) that optimize longevity or power usage under various considerations is similarly complex. In this case, a routing profile may be thought of as a mathematical function that predicts the past or future power usage from the entire computer network. In this case, the parameters of the function are the device profiles (243), which themselves depend on the device data (208) and the facility data (230), and the possible arrangements of the computer network or the range of possible network topologies according to the available devices. That is, given the device profiles (243), a specified network topology, a total power usage of the computer network may be determined by a routing profile. Thus, various routing profiles may be determined, each resulting in a different amount of power that is used by the computer network, as well as a different amount of individual power that used by each member of the computer network (e.g., computer (100)), computer network device A (204), computer network device B (206)). Again, given the complexity of such a mathematical function, a machine learning model (e.g., machine learning model X (273)) may be well suited for its approximation.

The device data (208), and the facility data (230) be pre-processed before being processed by smart engine (112) or the sustainability module (248). Pre-processing may include activities such as, numericalization, filtering and/or smoothing of the data, scaling (e.g., normalization) of the data, feature selection, outlier removal (e.g., z-outlier filtering) and feature engineering. Feature selection includes identifying and selecting a subset of operation data with the greatest discriminative power with respect to predicting future states of the members of the computer network (e.g., computer (100)), computer network device A (204), computer network device B (206)), including their power usage. Consequently, in some embodiments, not all of the device data (208) or facility data (230) need be passed to the smart engine (112). Feature engineering encompasses combining, or processing, various device data (208) and facility data (230) to create derived quantities. The derived quantities can be processed by the smart engine (112). For example, the device data (208) may be processed by one or more “basis” functions such as a polynomial basis function or a radial basis function. In some embodiments, the device data (208) and facility data (230) is passed to the smart engine (112) without pre-processing. Many additional pre-processing techniques exist such that one with ordinary skill in the art would not interpret those listed here as a limitation on the present disclosure.

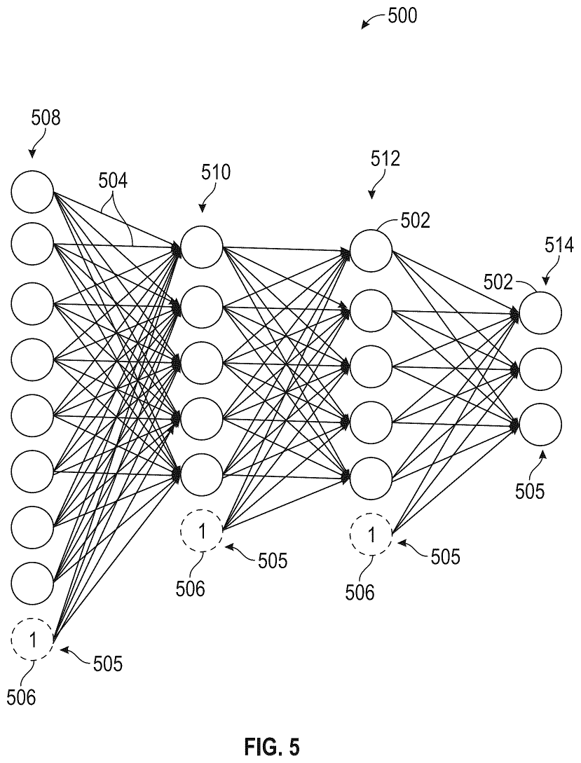

In accordance with one or more embodiments, the machine learning model used by the smart engine (112) may be a neural network. A diagram of a neural network is shown in FIG. 5. At a high level, a neural network (500) may be graphically depicted as being composed of nodes (502), where here any circle represents a node, and edges (504), shown here as directed lines. The nodes (502) may be grouped to form layers (505). FIG. 5 displays four layers (508, 510, 512, 514) of nodes (502) where the nodes (502) are grouped into columns, however, the grouping need not be as shown in FIG. 5. The edges (504) connect the nodes (502). Edges (504) may connect, or not connect, to any node(s) (502) regardless of which layer (505) the node(s) (502) is in. That is, the nodes (502) may be sparsely and residually connected. A neural network (500) will have at least two layers (505), where the first layer (508) is considered the “input layer” and the last layer (514) is the “output layer.” Any intermediate layer (510, 512) is usually described as a “hidden layer”. A neural network (500) may have zero or more hidden layers (510, 512) and a neural network (500) with at least one hidden layer (510, 512) may be described as a “deep” neural network or as a “deep learning method.” In general, a neural network (500) may have more than one node (502) in the output layer (514). In this case the neural network (500) may be referred to as a “multi-target” or “multi-output” network.

Nodes (502) and edges (504) carry additional associations. Namely, every edge is associated with a numerical value. The edge numerical values, or even the edges (504) themselves, are often referred to as “weights” or “parameters.” While training a neural network (500), numerical values are assigned to each edge (504). Additionally, every node (502) is associated with a numerical variable and an activation function. Activation functions are not limited to any functional class, but traditionally follow the form:

$$A = f ( {\sum }_{i ∈ ( incoming )} [ {( node value )}_{i} {( edge value )}_{i} ] ) , \qquad ( 2 ) ,$$

where i is an index that spans the set of “incoming” nodes (502) and edges (504) and ƒ is a user-defined function. Incoming nodes (502) are those that, when viewed as a graph (as in FIG. 5), have directed arrows that point to the node (502) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max (0, x), however, many additional functions are commonly employed. Every node (502) in a neural network (500) may have a different associated activation function. Often, as a shorthand, activation functions are described by the function ƒ by which it is composed. That is, an activation function composed of a linear function ƒ may simply be referred to as a linear activation function without undue ambiguity.

When the neural network (500) receives an input, the input is propagated through the network according to the activation functions and incoming node (502) values and edge (504) values to compute a value for each node (502). That is, the numerical value for each node (502) may change for each received input. Occasionally, nodes (502) are assigned fixed numerical values, such as the value of 1, that are not affected by the input or altered according to edge (504) values and activation functions. Fixed nodes (502) are often referred to as “biases” or “bias nodes” (506), displayed in FIG. 5 with a dashed circle.

In some implementations, the neural network (500) may contain specialized layers (505), such as a normalization layer, or additional connection procedures, like concatenation. One skilled in the art will appreciate that these alterations do not exceed the scope of this disclosure.

The training procedure for the neural network (500) comprises assigning values to the edges (504). To begin training the edges (504) are assigned initial values. These values may be assigned randomly, assigned according to a prescribed distribution, assigned manually, or by some other assignment mechanism. Once edge (504) values have been initialized, the neural network (500) may act as a function, such that it may receive inputs and produce an output. As such, at least one input is propagated through the neural network (500) to produce an output. A given data set will be composed of inputs and associated target(s), where the target(s) represent the “ground truth,” or the otherwise desired output. In accordance with one or more embodiments, in order to determine a device profile, the input of the neural network is the device data (which may be pre-processed) and the facility data (which may be pre-processed) while the target may be the power usage of the specific device. In the case of determining power usage of the entire computer network, the inputs include the device profiles and the possible topologies of the computer network.

The neural network (500) output is compared to the associated input data target(s). The comparison of the neural network (500) output to the target(s) is typically performed by a so-called “loss function;” although other names for this comparison function such as “error function,” “misfit function,” and “cost function” are commonly employed. To calculate a loss function in the case of determining a device profile, the power usage of one of the members of the computer network device must be known for various values of device data and facility data at least in a few example settings. Such data may come from historical records or from simulations. To calculate a loss function in the case of determining the power usage of the entire computer network, the total power usage for the computer network must be known for various possible device data and network topologies. Again, such data may come from historical records or simulations.

Many types of loss functions are available, such as the mean-squared-error function, however, the general characteristic of a loss function is that the loss function provides a numerical evaluation of the similarity between the neural network (500) output and the associated target(s). The loss function may also be constructed to impose additional constraints on the values assumed by the edges (504), for example, by adding a penalty term, which may be physics-based, or a regularization term. Generally, the goal of a training procedure is to alter the edge (504) values to promote similarity between the neural network (500) output and associated target(s) over the data set. Thus, the loss function is used to guide changes made to the edge (504) values, typically through a process called “backpropagation.”

While a full review of the backpropagation process exceeds the scope of this disclosure, a brief summary is provided. Backpropagation consists of computing the gradient of the loss function over the edge (504) values. The gradient indicates the direction of change in the edge (504) values that results in the greatest change to the loss function. Because the gradient is local to the current edge (504) values, the edge (504) values are typically updated by a “step” in the direction indicated by the gradient. The step size is often referred to as the “learning rate” and need not remain fixed during the training process. Additionally, the step size and direction may be informed by previously seen edge (504) values or previously computed gradients. Such methods for determining the step direction are usually referred to as “momentum” based methods.

Once the edge (504) values have been updated, or altered from their initial values, through a backpropagation step, the neural network (500) will likely produce different outputs. Thus, the procedure of propagating at least one input through the neural network (500), comparing the neural network (500) output with the associated target(s) with a loss function, computing the gradient of the loss function with respect to the edge (504) values, and updating the edge (504) values with a step guided by the gradient, is repeated until a termination criterion is reached. Common termination criteria are: reaching a fixed number of edge (504) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (504) values are no longer intended to be altered, the neural network (500) is said to be “trained.”

Returning to FIG. 2, in accordance with one or more embodiments, the sustainability module (248) may include an adaptive network configurator (114). The adaptive network configurator (114) has been described briefly in reference to FIG. 1. To reiterate, the adaptive network configurator (114) is a system that may be operationally coupled to the computer network and that may communicates with the smart engine (112) as part of the sustainability module in order to enact changes to the computer network. Accordingly, the adaptive network configurator (114) is capable of changing both the physical and logical paths of computer network by assigning a routing profile, or path for the flow of network data, to the computer network. The adaptive network configurator (114) may be used to apply a routing profile to the computer network. Operationally, the adaptive network configurator (114) may be used to enact the command to the computer network facility (265) to apply the sustainability adjustment. Recall that the sustainability adjustment may optimize the power usage of one or more of the members of the computer network (e.g., computer (100), network device A (204), and network device B (206)). Given the flexibility to support many different possible computer network topologies according to different embodiments of the present disclosure, the adaptive network configurator (114) must be similarly flexible to interpret complex commands such that the optimal computer network is realized in the computer network facility.

Configuring a complex computer network that is stable is difficult. Accordingly, in one or more embodiments, the adaptive network configurator (114) may also make use of a machine learning model (e.g., machine learning model Y (272)). In such cases, the machine learning model (e.g., machine learning model Y (272)) of the adaptive network configurator (114) is used to interpret a routing profile, or the command to the computer network facility (265) into actions for arranging the computer network. The adaptive network configurator (114) may be a neural network similar to the neural network described in FIG. 5. Alternatively, the adaptive network configurator (114) may be use random forests, generalized linear models, Bayesian regression, or other machine learning models not described.

In accordance with one or more embodiments, the sustainability module (248) may also include an anomaly detector (255). The anomaly detector (255) is configured to determine an anomaly based on the processed device data (208) and the processed facility data (230) and report the anomaly to the user interface. An anomaly may include a particularly high computer temperature (e.g., computer temperature (211), network device A temperature (217), or network device B temperature (223)), power usage (e.g., computer power usage (213), network device A power usage (219), or network device B power usage (225)), or network traffic/throughput (e.g., computer throughput (215), network device A traffic (221), or network device B traffic (227)). Alternatively, or in addition, an anomaly may include a particularly high facility temperature (233), facility humidity (235), or an alert related to the facility proximate weather (237). A threshold for an anomaly may be determined based on historical values of device data (208) and facility data (230) either in relative or absolute terms. In one or more embodiments, detecting an anomaly with the anomaly detector (255) may automatically enforce a predefined “safe” routing profile to be enacted on the computer network facility. The predefined safe routing profile may be preset by a user or may be determined using the smart engine (112). Alternatively, or in addition, detecting an anomaly using the anomaly detector (255) may enforce the system to iterate the optimization routine to find a new routing profile that avoids the member of the computer network causing the anomaly.

Some anomalies are not easily detected by a value merely exceeding a threshold. Some anomalies are only discerned by careful analysis and extraction of patterns that may be exhibited in the device data (208) and the facility data (230). To this end, the anomaly detector may also utilize a machine learning model (e.g., machine learning model Z (274)). The machine learning model (e.g., machine learning model Z (274)) of the anomaly detector (255) may be a neural network similar to the neural network described in FIG. 5. Alternatively, the anomaly detector (255) may be use random forests, generalized linear models, Bayesian regression, or other machine learning models not described.

In accordance with one or more embodiments, one of the machine learning models described herein (e.g., machine learning model X (273), machine learning model Y (272), machine learning model Z (274)) may be a long short-term memory (LSTM) network. To best understand a LSTM network, it is helpful to describe the more general recurrent neural network, for which an LSTM may be considered a specific implementation.

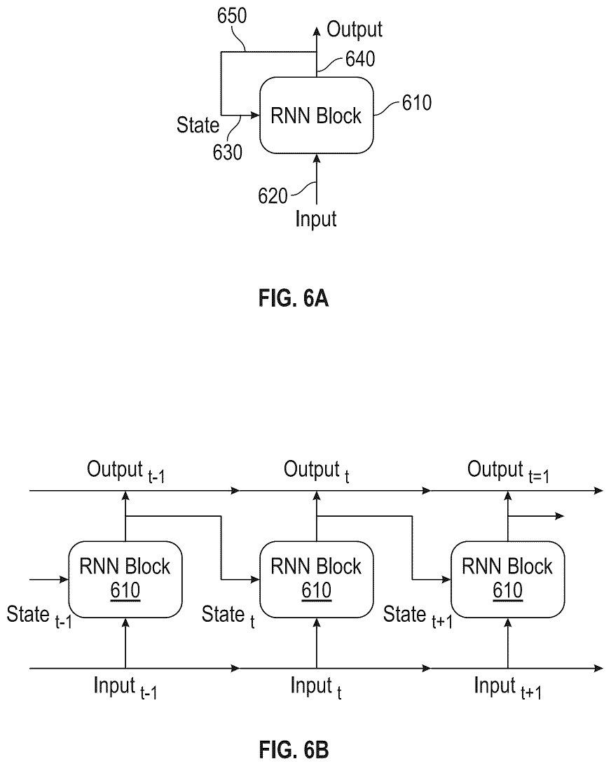

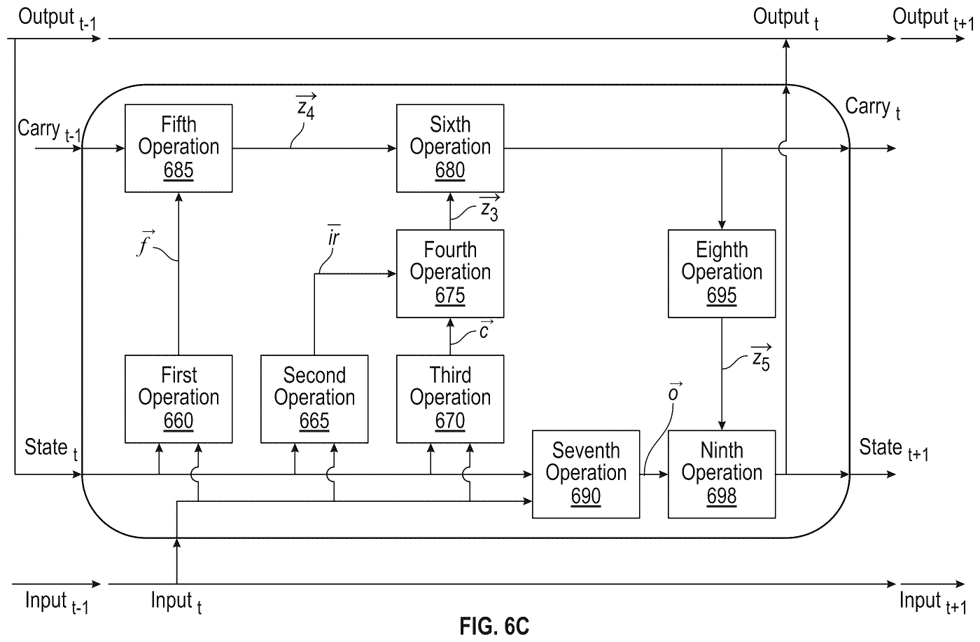

FIG. 6A depicts the general structure of a recurrent neural network (RNN). An RNN is graphically composed of an RNN Block (610) and a recurrent connection (650). The RNN Block may be thought of as a function which accepts an Input (620) and a State (630) and produces an Output (640). Without loss of generality, such a function may be written as

$$Output = RNN Block ( Input , State ) . \qquad ( 3 )$$

The RNN Block (610) generally comprises one or more matrices and one or more bias vectors. The elements of the matrices and bias vectors are commonly referred to as “weights” or “parameters” in the literature such that the matrices may be referenced as weight matrices or parameter matrices without ambiguity. It is noted that for situations with higher dimensional inputs (e.g., inputs with a tensor rank greater than or equal to 2), the weights of an RNN Block (610) may be contained in higher order tensors, rather than in matrices or vectors. For clarity, the present example will consider Inputs (620) as vectors or as scalars such that the RNN Block (610) comprises one or more weight matrices and bias vectors, however, one with ordinary skill in the art will appreciate that this choice does not impose a limitation on the present disclosure. Typically, an RNN Block (610) has two weight matrices and a single bias vector which are distinguished with an arbitrary naming nomenclature. A commonly employed naming convention is to call one weight matrix W and the other U and to reference the bias vector as b.

An important aspect of an RNN is that it is intended to process sequential, or ordered, data; for example, a time-series. In the RNN, the Input (620) may be considered a single part of a sequence. As an illustration, consider a sequence composed of Y parts. Each part may be considered an input, indexed by t, such that the sequence may be written as sequence=[input₁, input₂, inputₜ, . . . , input_{Y-1}, input_{Y}]. Each Input (620) (e.g., input₁ of a sequence) may be a scalar, vector, matrix, or higher-order tensor. Recall that a given seismic data set is composed of N_{c} traces (or channels) and Nₜ discrete time steps. In accordance with one or more embodiments, each Input (620) (or element of a sequence) is an array of traces at a single time step. That is, each Input (620) is considered a vector with N_{c} elements.

To process a sequence, an RNN receives the first ordered Input (620) of the sequence, input₁, along with a State (630), and processes them with the RNN Block (610) according to EQ. 4 to produce an Output (640). The Output (640) may be a scalar, vector, matrix, or tensor of any rank. For the present example, the Output (640) is considered a vector with k elements. The State (630) is of the same type and size as the Output (640) (e.g., a vector with k elements). For the first ordered input, the State (630) is usually initialized with all of its elements set to the value zero. For the second ordered Input (620), input₂, of the sequence, the Input (620) is processed similarly according to EQ. 4, however, the State (630) received by the RNN Block (610) is set to the value of the Output (640) determined when processing the first ordered Input (620). This process of assigning the State (630) the value of the last produced Output (640) is depicted with the recurrent connection (650) in FIG. 6A. All the Inputs (620) in a sequence are processed by the RNN Block (610) in this manner; that is, the State (630) associated with an Input (620) is the Output (640) of the RNN Block (610) produced by the previous Input (620) (with the exception of the first Input (620) in the sequence). In some implementations, each Output (640), one for each Input (610) within a sequence, is stored for later processing and use. In other implementations, only the final Output (640), or the Output (640) which is produced when the Input (620) input_{Y} is processed by the RNN Block (610), is retained.

In greater detail, the process of the RNN Block (610), or EQ. 4, may be generally written as:

$$Output = RNN Block ( input , state ) = f ( U \cdot state + W \cdot input + \vec{b} ) , \qquad ( 4 )$$

where W, U, and \vec{b} are the weight matrices and bias vector of the RNN Block (610), respectively, and ƒ is an “activation function.” Some functions for ƒ may include the and recur sigmoid function

$$f ( x ) = \frac{1}{1 + {e}^{- x}} ,$$

and rectified linear unit (ReLU) function ƒ(x)=max (0, x), however, many additional functions are commonly employed.

To further illustrate a RNN, a pseudo-code implementation of a RNN is as follows.

### RNN Algorithm

### Note:

N_{c}=input length
k=output length
W∈ [symbol] ^{k×k}
U∈ [symbol] ^{k×N}^{_{c}}
\vec{b}∈ [symbol] ^{k}
1: state=[0₁, 0₂, . . . , 0ₖ₋₁, 0ₖ]^{T}
2: for input in sequence:
3: \vec{z}₁=matmul (U, state)
4: \vec{z}₂=matmul (W, input)
5: output=ƒ(\vec{z}₁+\vec{z}₂+\vec{b})
6: state=output
   In keeping with the previous examples, both the inputs and the outputs are considered vectors of lengths N_{c} and k, respectively, however, in general, this need not be the case. With the lengths of these vectors defined, the shapes of the weight matrices, bias vector, and State (630) vector may be specified. To begin processing a sequence, the State (630) vector is initialized with values of zero as shown in line 1 of the pseudo-code. Note that in some implementations, the number of inputs contained within a sequence may not be known or may vary between sequences. One with ordinary skill in the art will recognize that an RNN may be implemented without knowing, beforehand, the length of the sequence to be processed. This is demonstrated in line 2 of the pseudo-code by indicating that each input in the sequence will be processed sequentially without specifying the number of inputs in the sequence. Once an Input (620) is received, a matrix multiplication operator is applied between the weight matrix U and the State (630) vector. The resulting product is assigned to the temporary variable \vec{z}₁. Likewise, a matrix multiplication operator is applied between the weight matrix W and the Input (610) with the result assigned to the variable \vec{z}₂. For the present example, due the Input (620) and Output (640) each being defined as vectors, the products in lines 3 and 4 of the pseudo-code may be expressed as matrix multiplications, however, in general, the dot product between the weight matrix and corresponding State (630) or Input (620) may be applied. The Output (640) is determined by summing \vec{z}₁, \vec{z}₂, and the bias vector b and applying the activation function ƒ elementwise. The State (630) is set to the Output (640) and the whole process is repeated until each Input (620) in a sequence has been processed.

FIG. 6B depicts an “unrolled” version of the RNN of FIG. 6A. Unrolling the RNN allows one to see how the sequential inputs, indexed by t, produce sequential outputs and how the state is passed through various inputs of the sequence. It is noted that while the “unrolled” depiction shows multiple RNN Blocks (610), these blocks are the same such that they are comprised of the same weight matrices and bias vector.

As previously stated, generally, training a machine-learned model requires that pairs of inputs and one or more targets (i.e., a training dataset) are passed to the machine-learned model. During this process the machine-learned model “learns” a representative model which maps the received inputs to the associated outputs. In the context of an RNN, the RNN receives a sequence, wherein the sequence can be partitioned into one or more sequential parts (Inputs (620) above), and maps the sequence to an overall output, which may also be a sequence. To remove ambiguity and distinguish the overall output of an RNN from any intermediate Outputs (640) produced by the RNN Block (610), the overall output will be referred to herein as a RNN result. In other words, an RNN receives a sequence and returns a RNN result. The training procedure for a RNN comprises assigning values to the weight matrices and bias vector of the RNN Block (610). For brevity, the elements of the weight matrices and bias vector will be collectively referred to as the RNN weights. To begin training the RNN weights are assigned initial values. These values may be assigned randomly, assigned according to a prescribed distribution, assigned manually, or by some other assignment mechanism. Once the RNN weights have been initialized, the RNN may act as a function, such that it may receive a sequence and produce a RNN result. As such, at least one sequence may be propagated through the RNN to produce a RNN result. For training, a training dataset is composed of one or more sequences and desired RNN results, where the desired RNN results represent the “ground truth”, or the true RNN results that should be returned for the given sequences. For clarity, and consistency with previous discussions of machine-learned model training, the desired or true RNN results will be referred to as targets. When processing sequences, the RNN result produced by the RNN is compared to the associated target. The comparison of a RNN result to the target(s) is typically performed by a loss function. As before, other names for this comparison function such as “error function” and “cost function” are commonly employed. Many types of loss functions are available, such as the mean squared error function, however, the general characteristic of a loss function is that the loss function provides a numerical evaluation of the similarity between the RNN result and the associated target(s). The loss function may also be constructed to impose additional constraints on the values assumed by RNN weights, for example, by adding a penalty term, which may be physics-based, or a regularization term. Generally, the goal of a training procedure is to alter the RNN weights to promote similarity between the RNN results and associated targets over the training dataset. Thus, the loss function is used to guide changes made to the RNN weights, typically through a process called “backpropagation through time.”

A long short-term memory (LSTM) network may be considered a specific, and more complex, instance of a recurrent neural network (RNN). FIG. 6C is an unrolled depiction of a LSTM where the internal components of the LSTM are displayed as labelled abstractions. A LSTM, like a RNN, has a recurrent connection, such that the output produced by a single input in a sequence is forwarded as the state to be used with the subsequent input. However, an LSTM also possesses another “state-like” data structure commonly referred to as the “carry.” The carry, like the state and input may be a scalar, vector, matrix, or tensor of any rank depending on the context of the application. Like unto the description of the RNN, for simplicity, the carry will be considered a vector in the following discussion of the LSTM. The LSTM receives an input, state, and carry and produces an output and a new carry. The output and the new carry are passed to the LSTM as the state and carry for the subsequent input. This sequential process, indexed by t, may be described functionally as:

$$( {output}_{t} , {carry}_{t} ) = LSTM Block ( {input}_{t} , {carry}_{t - 1} , {state}_{t} ) = LSTM Block ( {input}_{t} , {carry}_{t - 1} , {output}_{t - 1} ) , \qquad ( 5 )$$

where the LSTM Block, like the RNN Block, comprises one or more weight matrices and bias vectors and the processing steps necessary to transform an input, state, and carry to an output and new carry.

LSTMs may be configured in a variety of ways, however, the processes depicted in FIG. 6C are the most common. As shown in FIG. 6C, an LSTM Block receives an input (inputₜ), a state (stateₜ), and a carry (carryₜ₋₁). Again, assuming that the inputs, carry, and outputs are all vectors, the weights of the LSTM Block may be considered to reside in eight matrices and four bias vectors. These matrices and vectors are conventionally named Wᵢ, Uᵢ, W_{f}, U_{f}, W_{c}, U_{c}, W_{c}, U_{c} and \vec{b}ᵢ, \vec{b}_{ƒ}, \vec{b}_{c}, \vec{b}ₒ, respectively. The processes of the LSTM Block are as follows. Block 660 represents the following first operation:

$$\vec{f} = {a}_{1} ( {U}_{f} \cdot {state}_{t} + {W}_{f} \cdot {input}_{t} + {\vec{b}}_{f} ) , \qquad ( 6 )$$

where α₁ is an activation function applied elementwise to the result of the parenthetical expression and the resulting vector is \vec{ƒ}. Block 665 implements the following second operation:

$$\vec{ι} = {a}_{2} ( {U}_{i} \cdot {state}_{t} + {W}_{i} \cdot {input}_{t} + {\vec{b}}_{i} ) , \qquad ( 7 )$$

Where α₂ is an activation function which may be the same or different to α₁ and is applied elementwise to the result of the parenthetical expression. The resulting vector is \vec{l}. Block 670 implements the following third operation:

$$\vec{c} = {a}_{3} ( {U}_{c} \cdot {state}_{t} + {W}_{c} \cdot {input}_{t} + {\vec{b}}_{c} ) , \qquad ( 8 )$$

where α₃ is an activation function which may be the same or different to either α₁ or α₂ and is applied elementwise to the result of the parenthetical expression. The resulting vector is \vec{c}. In block 675, vectors \vec{l} and \vec{c} are multiplied according to a fourth operation:

$${\vec{z}}_{3} = \vec{ι} ⊙ \vec{c} , \qquad ( 9 )$$

where ⊙ indicates the Hadamard product (i.e., elementwise multiplication). Likewise, in block 685 the carry vector from the previous sequential input (carryₜ₋₁) vector and the vector \vec{ƒ} are multiplied according to a fifth operation:

$${\vec{z}}_{4} = {carry}_{t - 1} ⊙ \vec{f} . \qquad ( 10 )$$

The results of the operations of blocks 675 and 685 (\vec{z}₃ and \vec{z}₄, respectively) are added together in block 680, a sixth operation, to form the new carry (carryₜ):

$${carry}_{t} = {\vec{z}}_{3} + {\vec{z}}_{4} . \qquad ( 11 )$$

In block 690, the current input and state vectors are processed according to a seventh operation:

$$\vec{o} = {a}_{4} ( {U}_{o} \cdot {state}_{t} + {W}_{o} \cdot {input}_{t} + {\vec{b}}_{o} ) , \qquad ( 12 )$$

Where α₄ is an activation function which may be unique or identical to any other used activation function and is applied elementwise to the result of the parenthetical expression. The result is the vector \vec{o}. In block 695, an eighth operation, the new carry (carryₜ) is passed through an activation function α₅. The activation α₅ is usually the hyperbolic tangent function but may be any known activation function. The eighth operations (block 695) may be represented as:

$${\vec{z}}_{5} = {a}_{5} ( {carry}_{t} ) . \qquad ( 13 )$$

Finally, the output of the LSTM Block (output t) is determined in block 698 by taking the Hadamard product of \vec{z}₅ and \vec{o}, a ninth operation shown mathematically as:

$${output}_{t} = {\vec{z}}_{5} ⊙ \vec{o} . \qquad ( 14 )$$

The output of the LSTM Block is used as the state vector for the subsequent input. Again, as in the case of the RNN, the outputs of the LSTM Block applied to a sequence of inputs may be stored and further processed or, in some implementations, only the final output is retained. While the processes of the LSTM Block described above used vector inputs and outputs, it is emphasized that an LSTM network may be applied to sequences of any dimensionality. In these circumstances the rank and size of the weight tensors will change accordingly. One with ordinary skill in the art will recognize that there are many alterations and variations that can be made to the general LSTM structure described herein, such that the description provided does not impose a limitation on the present disclosure.

While multiple embodiments using different ML models have been suggested, one skilled in the art will appreciate that the methods and systems of the present disclosure are not limited to the listed ML models. ML models such as a random forest, support vector machines, or non-parametric methods such as K-nearest neighbors may be readily inserted into this framework and do not depart from the scope of this disclosure.

Embodiments may be implemented on a computer system. FIG. 7 is a block diagram of a computer system (702) used to provide computational functionalities associated with described algorithms, methods, functions, processes, flows, and procedures as described in the instant disclosure, according to one or more embodiments. The illustrated computer (702) is intended to encompass any computing device such as a server, desktop computer, laptop/notebook computer, wireless data port, smart phone, personal data assistant (PDA), tablet computing device, one or more processors within these devices, or any other suitable processing device such as an edge computing device, including both physical or virtual instances (or both) of the computing device. An edge computing device is a dedicated computing device that is, typically, physically adjacent to the process or control with which it interacts. For example, the ML model may be implemented on an edge computing device.

Additionally, the computer (702) may include a computer that includes an input device, such as a keypad, keyboard, touch screen, or other device that can accept user information, and an output device that conveys information associated with the operation of the computer (702), including digital data, visual, or audio information (or a combination of information), or a GUI.

The computer (702) can serve in a role as a client, network component, a server, a database or other persistency, or any other component (or a combination of roles) of a computer system for performing the subject matter described in the instant disclosure. In some implementations, one or more components of the computer (702) may be configured to operate within environments, including cloud-computing-based, local, global, or other environment (or a combination of environments).

At a high level, the computer (702) is an electronic computing device operable to receive, transmit, process, store, or manage data and information associated with the described subject matter. According to some implementations, the computer (702) may also include or be communicably coupled with an application server, e-mail server, web server, caching server, streaming data server, business intelligence (BI) server, or other server (or a combination of servers).

The computer (702) can receive requests over network (730) from a client application (for example, executing on another computer (702) and responding to the received requests by processing the said requests in an appropriate software application. In addition, requests may also be sent to the computer (702) from internal users (for example, from a command console or by other appropriate access method), external or third-parties, other automated applications, as well as any other appropriate entities, individuals, systems, or computers.

Each of the components of the computer (702) can communicate using a system bus (703). In some implementations, any or all of the components of the computer (702), both hardware or software (or a combination of hardware and software), may interface with each other or the interface (704) (or a combination of both) over the system bus (703) using an application programming interface (API) (712) or a service layer (713) (or a combination of the API (712) and service layer (713). The API (712) may include specifications for routines, data structures, and object classes. The API (712) may be either computer-language independent or dependent and refer to a complete interface, a single function, or even a set of APIs. The service layer (713) provides software services to the computer (702) or other components (whether or not illustrated) that are communicably coupled to the computer (702). The functionality of the computer (702) may be accessible for all service consumers using this service layer. Software services, such as those provided by the service layer (713), provide reusable, defined business functionalities through a defined interface. For example, the interface may be software written in JAVA, C++, or other suitable language providing data in extensible markup language (XML) format or another suitable format. While illustrated as an integrated component of the computer (702), alternative implementations may illustrate the API (712) or the service layer (713) as stand-alone components in relation to other components of the computer (702) or other components (whether or not illustrated) that are communicably coupled to the computer (702). Moreover, any or all parts of the API (712) or the service layer (713) may be implemented as child or sub-modules of another software module, enterprise application, or hardware module without departing from the scope of this disclosure.

The computer (702) includes an interface (704). Although illustrated as a single interface (704) in FIG. 7, two or more interfaces (704) may be used according to particular needs, desires, or particular implementations of the computer (702). The interface (704) is used by the computer (702) for communicating with other systems in a distributed environment that are connected to the network (730). Generally, the interface (704) includes logic encoded in software or hardware (or a combination of software and hardware) and operable to communicate with the network (730). More specifically, the interface (704) may include software supporting one or more communication protocols associated with communications such that the network (730) or interface's hardware is operable to communicate physical signals within and outside of the illustrated computer (702).

The computer (702) includes at least one computer processor (705). Although illustrated as a single computer processor (705) in FIG. 7, two or more processors may be used according to particular needs, desires, or particular implementations of the computer (702). Generally, the computer processor (705) executes instructions and manipulates data to perform the operations of the computer (702) and any algorithms, methods, functions, processes, flows, and procedures as described in the instant disclosure.

The computer (702) also includes a memory (706) that holds data for the computer (702) or other components (or a combination of both) that can be connected to the network (730). The memory may be a non-transitory computer readable medium. For example, memory (706) can be a database storing data consistent with this disclosure. Although illustrated as a single memory (706) in FIG. 7, two or more memories may be used according to particular needs, desires, or particular implementations of the computer (702) and the described functionality. While memory (706) is illustrated as an integral component of the computer (702), in alternative implementations, memory (706) can be external to the computer (702).

The application (707) is an algorithmic software engine providing functionality according to particular needs, desires, or particular implementations of the computer (702), particularly with respect to functionality described in this disclosure. For example, application (707) can serve as one or more components, modules, applications, etc. Further, although illustrated as a single application (707), the application (707) may be implemented as multiple applications (707) on the computer (702). In addition, although illustrated as integral to the computer (702), in alternative implementations, the application (707) can be external to the computer (702).

There may be any number of computers (702) associated with, or external to, a computer system containing computer (702), wherein each computer (702) communicates over network (730). Further, the term “client,” “user,” and other appropriate terminology may be used interchangeably as appropriate without departing from the scope of this disclosure. Moreover, this disclosure contemplates that many users may use one computer (702), or that one user may use multiple computers (702).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method comprising:
transmitting network data between a computer and a plurality of computer network devices;
obtaining device data from the computer and the plurality of computer network devices,
wherein the device data comprises a power usage of the plurality of computer network devices;
obtaining facility data from a computer network facility housing the computer and the plurality of computer network devices, the facility data comprising a facility temperature;
storing the device data and the facility data in a system database;
processing the device data and the facility data using a sustainability module resulting in a computer network metrics summary;
wherein the computer network metrics summary comprises at least a portion of the processed device data and the processed facility data;
updating the system database using the computer network metrics summary;
transmitting the computer network metrics summary to a user interface;
determining, via the user interface, a sustainability adjustment to the computer and the plurality of computer network devices based, at least in part, on the computer metrics summary; and
applying the sustainability adjustment to the computer and the plurality of computer network devices;
wherein applying the sustainability adjustment optimizes the power usage of the plurality of computer network devices.

2. The method of claim 1, wherein the sustainability adjustment changes the transmission of the network data between the computer and the plurality of computer network devices.

3. The method of claim 2, wherein the sustainability adjustment changes the transmission of the network data between the computer and the plurality of computer network devices while maintaining a communication link between the computer and at least one of the plurality of computer network devices.

4. The method of claim 1, wherein processing the device data and the facility data using the sustainability module comprises creating a device profile for each of the plurality of computer network devices, resulting in a plurality of device profiles.

5. The method of claim 4, wherein the device profile of each of the plurality of computer network devices comprises a record of past power usage of the computer network device.

6. The method of claim 4, wherein processing the device data and the facility data using the sustainability module further comprises creating a plurality of routing profiles for the transmission of network data between the computer and the plurality of computer network devices.

7. The method of claim 6, wherein each of the plurality of routing profiles defines a network data transmission pathway for the transmission of network data between the computer and the plurality of computer network devices based, at least in part, on the device data and the facility data.

8. The method of claim 6, wherein the sustainability module comprises a smart engine that uses at least one machine learning model to process the device data and the facility data.

9. The method of claim 7, wherein the computer network metrics summary is created based on the plurality of device profiles and the plurality of routing profiles and the sustainability adjustment is applied to the computer and the plurality of computer network devices automatically.

10. The method of claim 1, wherein the sustainability module comprises an anomaly detector configured to determine an anomaly based on the device data and the facility data and report the anomaly to the user interface.

11. A system comprising:
a computer network facility housing a computer and a plurality of computer network devices;
a system database communicatively coupled to the computer and the plurality of computer network devices;
a user interface communicatively coupled to the system database;
a sustainability module communicatively coupled to the user interface and the system database;
wherein the computer and the plurality of computer network devices are configured to transmit network data between the computer and the plurality of computer network devices;
wherein the system database is configured to:
receive device data from the computer and the plurality of computer network devices,
wherein the device data comprises a power usage of the plurality of computer network devices,
receive facility data from a computer network facility housing the computer and the plurality of computer network devices, the facility data comprising a facility temperature, and
store the device data and the facility data;
wherein the sustainability module is configured to:
process the device data and the facility data resulting in a computer network metrics summary,
wherein the computer network metrics summary comprises at least a portion of the processed device data and the processed facility data,
update the system database using the computer network metrics summary, and
transmit the computer network metrics summary to the user interface,
wherein the user interface is configured to:
allow a determination of a sustainability adjustment to the computer and the plurality of computer network devices based, at least in part, on the computer metrics summary, and
apply the sustainability adjustment to the computer and the plurality of computer network devices,
wherein applying the sustainability adjustment optimizes the power usage of the plurality of computer network devices.

12. The system of claim 11, wherein the sustainability adjustment changes the transmission of the network data between the computer and the plurality of computer network devices.

13. The system of claim 12, wherein the sustainability adjustment changes the transmission of the network data between the computer and the plurality of computer network devices while maintaining a communication link between the computer and at least one of the plurality of computer network devices.

14. The system of claim 11, wherein processing the device data and the facility data using the sustainability module comprises creating a device profile for each of the plurality of computer network devices, resulting in a plurality of device profiles.

15. The system of claim 14, wherein the device profile of each of the plurality of computer network devices comprises a record of past power usage of the computer network device.

16. The system of claim 14, wherein processing the device data and the facility data using the sustainability module further comprises creating a plurality of routing profiles for the transmission of network data between the computer and the plurality of computer network devices.

17. The system of claim 16, wherein each of the plurality of routing profiles defines a network data transmission pathway for the transmission of network data between the computer and the plurality of computer network devices based, at least in part, on the device data and the facility data.

18. The system of claim 16, wherein the sustainability module comprises a smart engine that uses at least one machine learning model to process the device data and the facility data.

19. The system of claim 17, wherein the computer network metrics summary is created based on the plurality of device profiles and the plurality of routing profiles and the sustainability adjustment is applied to the computer and the plurality of computer network devices automatically.

20. The system of claim 11, wherein the sustainability module comprises an anomaly detector configured to determine an anomaly based on the device data and the facility data and report the anomaly to the user interface.
